(19) United States
(12) Patent Application Publication
(10) Pub. No.: US 2007/0240389 A1
(43) Pub. Date: Oct. 18, 2007

(54) BINDING MATERIAL FOR WRAPPING MATERIAL THAT HAS BEEN SHAPED AND/OR PRESSED INTO BALES

(76) Inventor: Ludger Frerichs, Sassenberg (DE)

Correspondence Address: STRIKER, STRIKER & STENBY, 103 EAST NECK ROAD, HUNTINGTON, NY, 11743, US

(21) Appl. No.: 11/695,729

(22) Filed: Apr. 3, 2007

(30) Foreign Application Priority Data
Apr. 3, 2006 (DE) 10 2006 015 854.7

(51) Int. Cl. B30B 9/30; B30B 5/06; B65B 11/56; B65B 13/00

(52) U.S. Cl. 53/587; 100/88

(57) ABSTRACT

A binding material is provided for wrapping material, such as crop material or waste material that has been shaped and/or pressed into bales, a bale includes the inventive binding material, and a baler forms the bale. The binding material includes at least one electronic memory medium integrated in the binding material. In this manner it is ensured that the memory medium is incorporated with the bale when the bale is bound, and that it can be removed from the bale when the binding material is removed from the bale, no additional measures are required to remove the memory medium from the bale.

### CROSS-REFERENCE TO A RELATED APPLICATION

The invention described and claimed hereinbelow is also described in German Patent Application DE 10 2006 015 854.7 filed on Apr. 3, 2006. This German Patent Application, whose subject matter is incorporated here by reference, provides the basis for a claim of priority of invention under 35 U.S.C. 119 (a)-(d).

### BRIEF DESCRIPTION OF THE DRAWINGS

The present invention relates to a binding material for wrapping material, such as crop material or waste material, that has been shaped and/or pressed into bales.

A system for storing bale-specific data is made known in EP 1 053 673. Using various types of sensors, the parameters of the crop material that has been shaped in to a bale and bound with twine are registered and transmitted via radio to a transponder. The transponder is inserted into the interior of the bale using a device. The parameters stored on the transponder can be read out remotely using a reading device.

The disadvantage of this device is that a separate insertion device is required on the baler, which inserts the transponder in the bale. It is also necessary to manually remove the transponder from the bale before the bale is fed to animals. Transponders also typically have the disadvantage that they must include an energy source, such as a battery. As a result, transponders of this type are relatively large in design.

### SUMMARY OF THE INVENTION

The object of the present invention, therefore, is to avoid the disadvantages of the related art and, in particular, to place a memory medium on the bale in a manner such that a special device is not required to do so, and which allows the memory medium to be removed easily from the bale when the bale is unwrapped.

Accordingly, it is an object of the present invention to provide a binding material for wrapping material that has been shaped and/or pressed into bales, the binding material comprising a binding material element; and at least one electronic memory medium integrated in said binding material element.

Given that at least one electronic memory medium is incorporated in the binding material, the memory medium is incorporated with the bale when the bale is bound, and it can be removed from the bale along with the binding material when the binding material is removed from the bale; no additional measures are required to remove the memory medium from the bale.

In an advantageous embodiment of the present invention, the electronic memory medium is designed as a memory chip, so that data can be stored on the chip in a contactless manner by a transmission device and so that the data can be read out in the same manner, using a reading device. In an advantageous embodiment of the present invention, the memory chip is designed as a RFID (Radio Frequency Identification) chip. This has the advantage, in particular, that technically mature, proven and cost-favorable data storage and recall technology can be used in relatively “raw” conditions.

In an advantageous embodiment of the present invention, the binding material is designed as twine, and the memory medium is woven directly in the twine. This has the advantage, in particular, that specific information can be assigned to a particular wrapped bale even when filamentary material is used, which is a technology commonly used to form crop material bales. A particularly cost-favorable embodiment results in this context when, when the material bale is wrapped with several strands of twine, the memory medium is integrated in only one of the strands of twine.

In a further advantageous embodiment of the present invention, the binding material is designed as a mesh strip, and the memory medium is woven into the binding material, so that, even when “mesh binding material” is used, information can be coupled to the particular bales, and no separate working steps are required to remove the required memory media.

In a further inventive design, the binding material is designed as plastic foil, and the memory medium is integrated in the plastic foil, e.g., via bonding or printing. In this manner, the inventive effects can also be ensured when plastic foils are used as the binding material.

Given that the memory medium is a different color than the binding material and/or the crop material, it is possible to quickly determine where the memory medium is located on the circumference of the bale, thereby eliminating the need to spend time searching in order to read out information.

In an advantageous embodiment of the present invention, the binding material can be rolled onto a supply roller, and several memory media are integrated in the roll-up direction of the supply roller at spacial intervals, so that every bale bound with a section of the binding material is provided with at least one memory medium.

Given that the distance between each of the memory media is chosen such that, after the bale is bound with a section of the binding material, at least two memory media are located on the circumference of the bale, it is possible to identify the bale even when a memory medium becomes damaged during roll-up or when the binding material is cut, or when the bale is set down on its underside and the memory medium becomes stuck in an unreachable position.

Given that bale-specific data are registered during the bale-forming procedure and are transmitted wirelessly via a data transmission device to the memory media located on the circumference of the bale, it is possible to trace every single bale using the data stored in the memory medium.

Advantageously, the bale-specific data include subsequent handling operations for the bales; the type and moisture content of the material; the mass, size and density of the bale; the location and time at which the bale was created and/or placed; the type of machine with which the bale was produced; the individual who fulfilled the order to bind the bale, and a number for the bale that was produced by a counter. The quality and quantity of the material can be determined in this manner. It is also possible to determine the type of handling the bales require, and/or whether and how the bales should be transported, and/or how and where the bales should be stored.

In an advantageous embodiment of the present invention, the bale-specific data include editable or non-editable data. This has the advantage, in particular, that data that determine bale handling and that can be adapted to highly diverse basic conditions, and non-editable data for documentation purposes, such as legal requirements for tracking agricultural crop materials in particular, can be stored in the memory medium.

In an advantageous embodiment of the present invention, a bale is provided, in the case of which data are stored in memory media located on the circumference of the bale after the wrapping procedure and independently of the baler in a manner that allows them to be edited and recalled. This has the advantage in particular that information can be assigned to and called up from the bale for as long as it exists. A particularly advantageous embodiment of the present invention results in this context when further machine systems that pick up the bales can transfer data to the memory media and call up data from the memory media.

In a further advantageous embodiment of the present invention, a baler for wrapping bales with binding material is provided, and a large number of memory media is integrated in the particular binding material in a manner according to the present invention.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

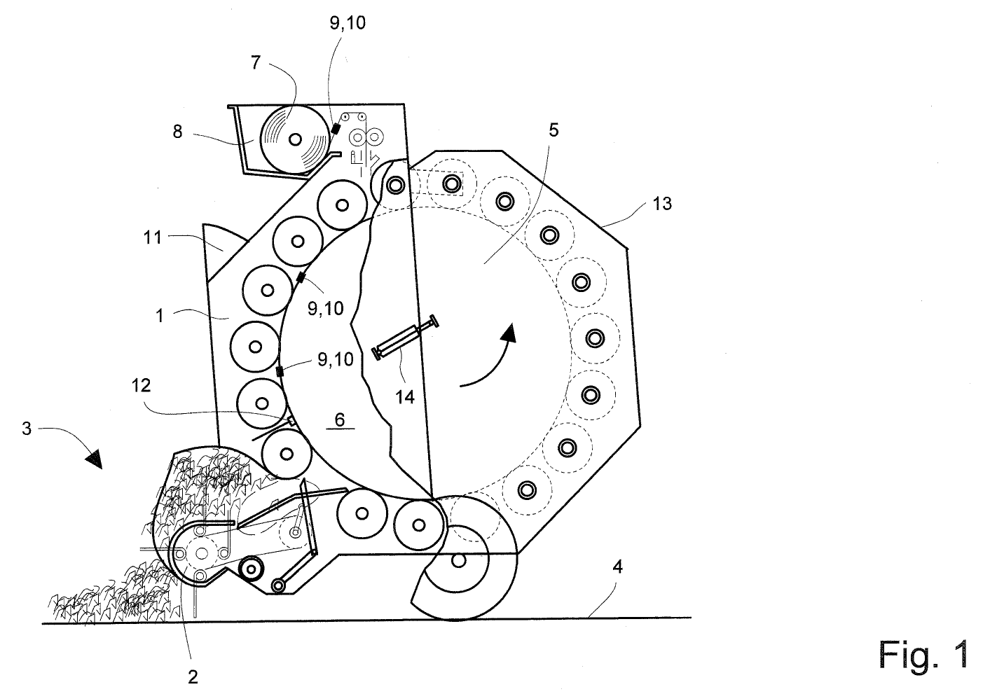

FIG. 1 shows a round baler for making crop material bales,

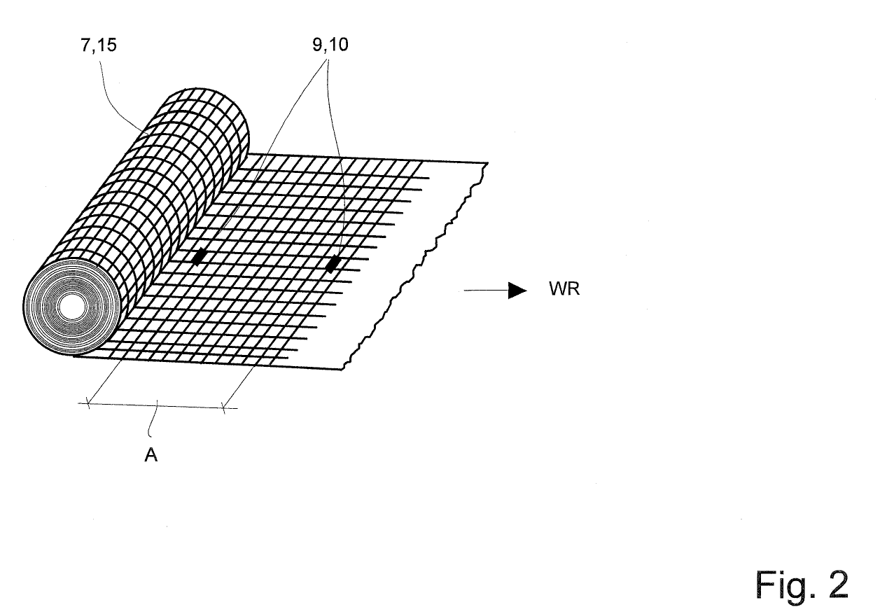

FIG. 2 shows a supply roller with an inventive binding material,

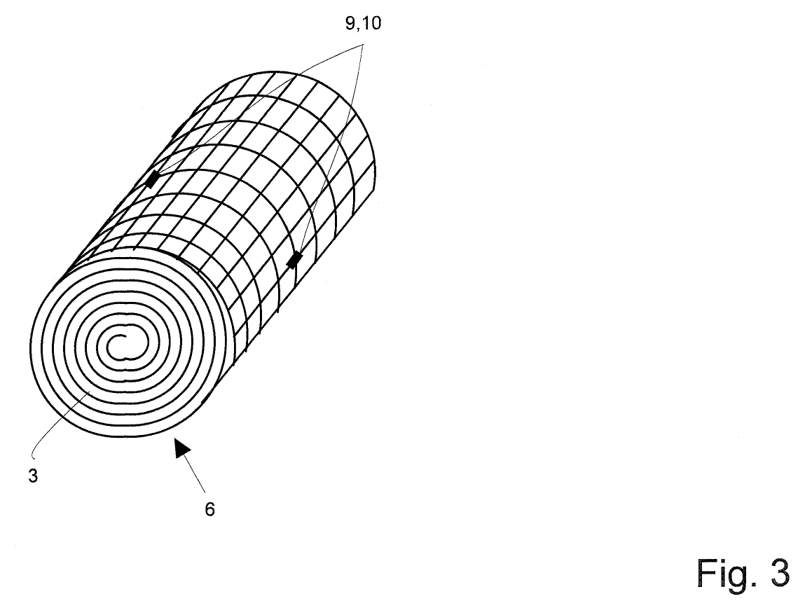

FIG. 3 shows a crop material bale that is bound with the inventive binding material.

### DESCRIPTION OF THE PREFERRED EMBODIMENTS

FIG. 1 shows a round baler 1 that is known per se. Round baler 1 includes a pick-up device 2, with which crop material 3 is collected from field 4 during the harvesting operation. Picked-up crop material 3 is conveyed to a bale chamber 5, the size of which is fixed. Inside bale chamber 5, crop material 3 is shaped and pressed to form a crop material bale 6. To secure the crop material bale 6, pressed crop material 3 is subsequently wrapped in bale chamber 5 with a section of a binding material (binding material element) 7, which is stored in a container 8 on round baler 1.

Several electronic memory media 10 designed as memory chips 9 are integrated, according to the present invention, in binding material 7, which will be explained in greater detail below, so that, after crop material 3 is bound, at least one memory chip 9—in which data can be stored—is located on the circumference of crop material bale 6.

During the bale binding procedure in round baler 1, bale-specific data such as the contents and moisture content of crop material 3, and the size, mass, and density of finished crop material bale 6 are determined via sensors that are located on round baler 1 and are known per se—so they will not be explained in greater detail—and this information is then transmitted to an evaluation unit 11. The bale-specific data can also include information about the location and time at which bale 6 was created and/or placed; the type of machine with which bale 6 was produced; the individual who fulfilled the order to bind the bale, and a number for bale 6 that was produced by a counter. Given that all or a selection of this bale-specific information is recallably stored in memory medium/media 10, the possibility is created—in a manner to be described in greater detail below—for easily implementing the ability to trace bales, and for coordinating the further bale logistics with this bale-specific information.

According to FIG. 1, baler 1 includes an evaluation unit 11 in which subsequent handling operations such as further handling or storage of crop material bale 6 are derived from bale-specific data that has been determined using sensors. Evaluation unit 11 is connected with a transmission device 12 located in the region of bale chamber 5 of round baler 1. Transmission device 12 wirelessly transmits the bale-specific data and the handling operations derived therefrom to memory chip 9 located on the circumference of crop material bale 6.

After crop material bale 6 has been bound and the data have been transmitted to memory media 10, tailgate 12 of round baler 1 is opened via hydraulic cylinders 14, and crop material bale 6 is ejected out of bale chamber 5 and lands on field 4.

Instead of collecting crop material 3 from a field 4 and pressing it into bales 6, as depicted in FIG. 1, it is also within the scope of the present invention to produce bales 6 composed of waste material using a suitable round baler, which is known per se and will therefore not be described in greater detail. Bales 6 produced in this manner are also wrapped with inventive binding material 7 in the manner described.

An embodiment of the present invention with particularly successful technical application results when memory chips 9 are designed as RFID (Radio Frequency Identification) chips. Chips of this type are cost-favorable and easy to manufacture, and they do not require an integrated energy accumulator, since separate read and write devices are used to transmit information to the chip and read it out, and these separate read and write devices include the energy accumulator required for data transmission.

FIG. 2 shows a supply roller 15 with an inventive binding material 7 that is designed as mesh strip 16 and is rolled onto supply roller 15. Electronic memory media 10 are woven into mesh strip 16 in roll-up direction WR of mesh strip 16 at equal distances A from each other. Distance A is chosen such that at least two memory media 10 are located on the circumference of crop material bale 6 after crop material bale 6 is bound (see FIG. 3). Balers are also known from the related art with which at least two strands of twine are used as binding material 7, which are wound simultaneously, in subregions, around crop material bale 6. Together, they therefore form a latticed binding. With this design of binding material 7, it is adequate according to the present invention when inventive memory media 10 are woven into only one strand of twine. It is within the framework of the present invention for binding material to also be designed as plastic foil in which, in the simplest case, inventive memory media 10 are integrated via bonding or printing.

For better detection, memory media 10 of particular binding materials 7 are also different colors than particular binding material 7 and crop material 3 to be bound. Distances A depicted in the figures are merely schematic and serve as examples. In a particularly preferred embodiment, distances A between adjacent memory media 10 are chosen to be so great that at least one memory medium 10 is always accessible, so that information can be read from crop material bale 6 or transmitted to it even when a memory medium 10 is positioned in the region of the bale resting surface and is therefore unaccessible. It can also be provided, however, that distances A are determined based on the bale diameter to be wrapped with binding material 7. In the simplest case, this can be ensured by manufacturing binding material 7 specifically for defined bale diameters or by integrating memory media 10 in binding material 7, directly on baler 1 itself, depending on the bale diameter that has been preselected on particular baler 1.

In a further advantageous embodiment it can also be provided that a large number of memory media 10 is positioned on the circumferential surface of a bale 6 after it is wrapped. Even though this results in higher costs for binding material 7 due to the larger number of integrated memory media, it is ensured that at least one memory medium 10 is always positioned in an easily accessed location on the circumferential surface of bale 6, thereby ensuring that memory media 10 can be easily written to and read from.

Memory media 10 can also be designed such that the data that can be stored on them are stored on particular memory medium 10 in an editable or non-editable manner. In the simplest case, particular memory chip 9 is subdivided into memory regions—which are either write-protected or editable—in a manner known per se. This is required, in particular, when data must be recorded in order to track crop material and about which it absolutely must be ensured that they cannot be subsequently changed, and when bale-specific and, in particular, bale-logistical data must be adaptable to changing basic conditions.

The editability of bale-specific data stored in the memory media is very significant in particular when the end customer or the intermediate storage position based on particular bale 6 changes. In this context it is also very significant that further machine systems in the entire bale logistics chain, such as transport vehicles and systems for controlling delivery to and from storage, are authorized to store additional information in particular memory media 10 on bales 6.

The use of inventive binding material 7 is not limited to the round baler depicted here. Instead, it can also be used for round balers with a changeable bale chamber, or for block balers.

It is within the scope of the ability of one skilled in the art to modify the exemplary embodiments described in a manner not presented, or to use them in other machines to achieve the effects described, without leaving the framework of the invention.

It will be understood that each of the elements described above, or two or more together, may also find a useful application in other types of materials differing from the type described above.

While the invention has been illustrated and described as embodied in a binding material for wrapping material that has been shaped and/or pressed into bales, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A binding material for wrapping material that has been shaped and/or pressed into bales, the binding material comprising a binding material element; and at least one electronic memory medium integrated in said binding material element.

2. A binding material as defined in claim 1, wherein said electronic memory medium is configured as a memory chip.

3. A binding material as defined in claim 1, wherein said memory chip is a radio frequency identification chip.

4. A binding material as defined in claim 1, wherein said binding material element is configured as a twine, while said memory means is woven into said twine.

5. A binding material as defined in claim 1, wherein said binding material element includes several strands of twine, said memory medium being integrated in only one of said strands of twine.

6. A binding material as defined in claim 1, wherein said binding material element is configured as a mesh strip, said memory medium being woven into said mesh strip.

7. A binding material as defined in claim 1, wherein said binding material element is configured as a plastic foil, said memory medium being integrated in said plastic foil.

8. A binding material as defined in claim 1, wherein said binding material element is configured as a plastic foil, said memory medium being configured as a memory medium selected from the group consisting of a memory medium bonded onto said plastic foil and memory medium printed onto said plastic foil.

9. A binding material as defined in claim 1, wherein said memory medium is configured so that it has a different color from a product selected from the group consisting of said binding material element, a crop material and both.

10. A binding material as defined in claim 1, wherein said binding material element is rolled up on a supply roller, while several said memory media are integrated in said binding material element at distances from each other in a roll-up direction of the supply roller.

11. A binding material as defined in claim 10, wherein said distance between said memory media is chosen such that, after the bale is wrapped with a section of said binding material element, at least two said memory media are located on a circumference of said bale.

12. A binding material as defined in claim 1, wherein said at least one electronic memory media contains a bale-specific data selected from the group consisting of handling operations for bales, contents and moisture content of a material, a mass, size and density of the bale, a location and time at which the bale was created and/or placed, a type of machine with which the bale was produced, an individual who fulfilled an order to bind the bale, and a number for the bale that was produced by a counter.

13. A binding material as defined in claim 1, wherein said at least one electronic memory medium contains bale-specific data selected from the group consisting of editable bale-specific data and non-editable bale-specific data.

14. A bale, comprising a bale element; and a binding material for wrapping material that has been shaped and/or pressed into said bale, said binding material including a binding material element; and at least one electronic memory medium integrated in said binding material element.

15. A bale as defined in claim 14, wherein data are stored in said at least one electronic memory medium located on a circumference of a bale after a wrapping procedure and independently of a baler in a manner that allows the data to be edited and recalled.

16. A bale as defined in claim 15, wherein said at least one electronic memory medium is formed so that further machine systems that pick up the bales can transfer the data to said electronic memory media and call up the data from said electronic memory medium.

17. A baler, comprising a baler unit for shaping and/or pressing crop material bales; and means for finding bales with a binding material, the binding material comprising a binding material element; and at least one electronic memory medium integrated in said binding material element.

18. A baler as defined in claim 17; and further comprising a transmission device by which bale-specific data recorded during a bale binding procedure are transmitted wirelessly by said transmission device to said electronic memory media located on a circumference of a bale.
